(19) United States
(12) Patent Application Publication
(10) Pub. No.: US 2017/0185924 A1
(43) Pub. Date: Jun. 29, 2017

(54) SERVER APPARATUS

(71) Applicant: TOSHIBA TEC KABUSHIKI KAISHA, Tokyo (JP)

(72) Inventor: Toshihiro Kaneko, Izunokuni Shizuoka (JP)

(21) Appl. No.: 15/384,444

(22) Filed: Dec. 20, 2016

(30) Foreign Application Priority Data
Dec. 28, 2015 (JP) 2015-257314

(51) Int. Cl. G06Q 10/02; G06Q 20/20

(52) U.S. Cl. CPC G06Q 10/02; G06Q 20/209; G06Q 20/202

(57) ABSTRACT

In accordance with an embodiment, a server apparatus which communicates with a portable terminal comprises a first reception module, a generation module and a transmission module. The first reception module receives a use status of each checkout apparatus which executes a checkout processing, using checkout information relating to checkout received from the portable terminal. The generation module generates image information including the use status of each checkout apparatus received by the first reception module, and an arrangement location of each checkout apparatus. The transmission module transmits the image information generated by the generation module to the portable terminal which displays the image information.

### CROSS-REFERENCE TO RELATED APPLICATION

This application is based upon and claims the benefit of priority from Japanese Patent Application No. 2015-257314, filed Dec. 28, 2015, the entire contents of which are incorporated herein by reference.

### FIELD

Embodiments described herein relate generally to a server apparatus.

### BACKGROUND

In recent years, in a store such as a specialty shop, a handy-terminal such as a tablet device is often used to perform a customer service. The tablet device is used by a store clerk to explain a commodity. In a case in which a customer determines to purchase a commodity, the tablet device is used for a commodity sales data processing.

The tablet device cannot issue a receipt because of no printer therein. The tablet device also cannot receive cash because of no drawer therein. Thus, it is necessary for the store clerk to guide the customer to an area where a checkout apparatus with the printer and the drawer is provided.

However, in a case in which there is a line at the checkout apparatus with the printer and the drawer in the area, the customer has to wait for until the checkout apparatus is enabled to be used.

### DESCRIPTION OF THE DRAWINGS

FIG. 1 is view illustrating an example of the arrangement of a POS system according to an embodiment;

FIG. 2 is an exploded perspective view illustrating an example of the appearances of a tablet device and a checkout apparatus;

FIG. 3 is a block diagram illustrating the hardware arrangement of a server apparatus;

FIG. 4 is a view illustrating the data structure of a checkout apparatus status table;

FIG. 5 is a block diagram illustrating the hardware arrangement of the tablet device;

FIG. 6 is a block diagram illustrating the hardware arrangement of the checkout apparatus;

FIG. 7 is a block diagram illustrating the functional components of each apparatus of the POS system;

FIG. 8 is a view illustrating an example of a reservation input image;

FIG. 9 is a flowchart illustrating an example of a display processing; and

FIG. 10 is a flowchart illustrating an example of a reservation processing.

### DESCRIPTION

In accordance with an embodiment, a server apparatus which communicates with a portable terminal comprises a first reception module, a generation module and a transmission module. The first reception module receives a use status of each checkout apparatus which executes a checkout processing, using checkout information relating to checkout received from the portable terminal. The generation module generates image information including the use status of each checkout apparatus received by the first reception module and an arrangement location of each checkout apparatus. The transmission module transmits the image information generated by the generation module to the portable terminal which displays the image information.

Hereinafter, an embodiment of the server apparatus is described in detail with reference to the accompanying drawings. The embodiment described later is an example of the server apparatus, and not intends to limit the arrangement and the specification thereof. The present embodiment is an example applicable to the server apparatus introduced to a store such as a specialty shop.

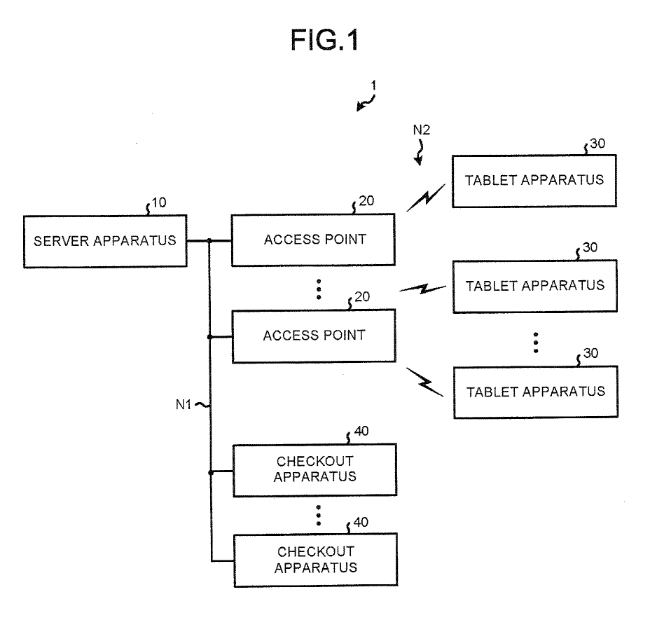

FIG. 1 is a view illustrating the arrangement of a POS (Point Of Sales) system 1 according to the present embedment. The POS system 1 of the embodiment includes a server apparatus 10, a plurality of access points 20, a plurality of tablet devices 30, and a plurality of checkout apparatuses 40. The POS system 1 may include a plurality of the server apparatuses 10.

The server apparatus 10, the access points 20 and the checkout apparatuses 40 are connected through a network N1. The network N1 connects each apparatus through a wired manner such as a LAN (Local Area Network) cable. The access points 20 and the tablet devices 30 are connected through a network N2. The network N2 connects each apparatus through a wireless LAN such as a Wi-Fi (Wireless Fidelity).

The server apparatus 10 is a personal computer for managing a status of each apparatus of the POS system 1. The access point 20 is a relay device for relaying communication between the tablet device 30 and each apparatus connected to the network N1.

The tablet device 30 is a portable terminal used by a store clerk in a specialty shop. The tablet device 30 displays commodity information of each commodity in the specialty shop. Thus, the store clerk can use the displayed commodity information to explain the commodity to a customer. The tablet device 30 can execute a commodity sales data processing. More particularly, the tablet device 30 executes a sales registration for registering a commodity to be sold through the commodity sales data processing. The tablet device 30 calculates change for cash deposited by the customer.

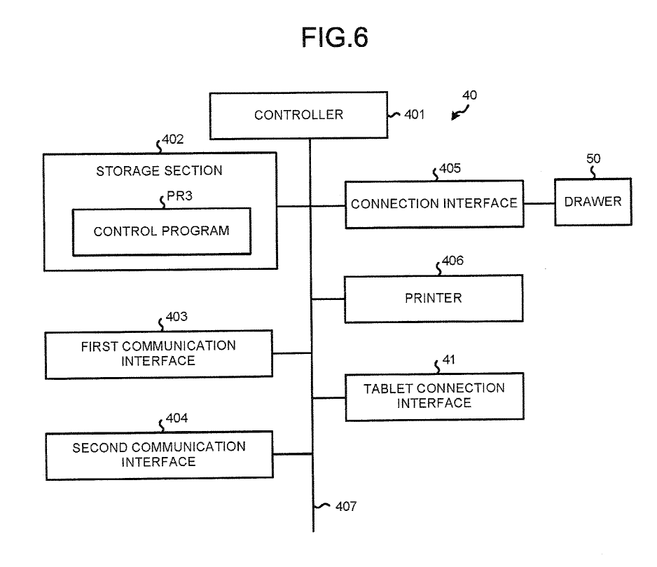

The checkout apparatus 40 uses checkout information relating to a settlement received from the tablet device 30 to execute a checkout processing. More particularly, the checkout apparatus 40 prints a receipt relating to one transaction. Alternatively, the checkout apparatus 40 controls opening and closing of a drawer 50 (refer to FIG. 6) connected with the checkout apparatus 40 via a connection interface 405 (refer to FIG. 6).

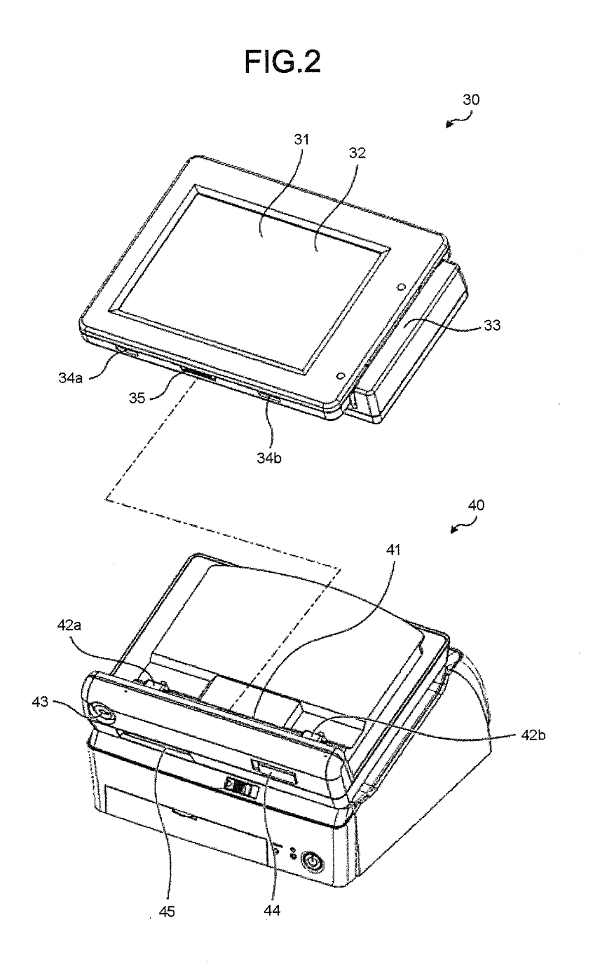

The tablet device 30 and the checkout apparatus 40 can be connected with each other via tablet connection interfaces 35 and 41 (refer to FIG. 2) described later to function as a POS terminal. FIG. 2 is an exploded perspective view illustrating appearances of the tablet device 30 and the checkout apparatus 40. The tablet device 30 comprises a display section 31, a touch panel 32, a card reader/writer 33, fixing member holes 34a and 34b, and the tablet connection interface 35. The checkout apparatus 40 comprises the tablet connection interface 41, fixing members 42a and 42b, a cylinder lock 43, a fixing member switch 44, and a receipt discharge port 45.

The display section 31 is, for example, a liquid crystal display device (LCD). The display section 31 is not limited to be a liquid crystal display device, but may also be an organic EL (Electro-luminescence) display device. The touch panel 32 detects a position on the display section 31 which is operated (touched) to determine that an operation corresponding to a display component (touched position) displayed on the display section 31 is input. In this way, the touch panel 32 receives the operation on a key as the key displayed on the display section 31 being operated.

The card reader/writer 33 executes reading and writing of information stored in a storage medium of a card used for a settlement such as a credit card. The fixing member holes 34a and 34b are holes into which members for fixing the tablet device 30 to the checkout apparatus 40 are inserted. The tablet connection interface 35 is an element at the tablet device 30 side for connecting the tablet device 30 with the checkout apparatus 40.

The tablet connection interface 41 is an element at the checkout apparatus 40 side for connecting the checkout apparatus 40 with the tablet device 30. The fixing members 42a and 42b are members for fixing the tablet device 30 to the checkout apparatus 40. The cylinder lock 43 restricts actions of the fixing members 42a and 42b for fixing the tablet device 30 and the checkout apparatus 40. In other words, the cylinder lock 43 permits actions of the fixing members 42a and 42b on condition that the cylinder lock 43 is unlocked by a cylinder key. In this way, the cylinder lock 43 prevents the tablet device 30 from being taken away. The fixing member switch 44 moves the fixing members 42a and 42b for fixing the tablet device 30 and the checkout apparatus 40. The fixing member switch 44 moves the fixing members 42a and 42b on condition that the cylinder lock 43 is unlocked. The receipt discharge port 45 discharges a receipt of a paper on which a printer 406 prints sales information of the commodity to which the checkout processing is carried out.

Next, each apparatus of the POS system 1 is described in detail.

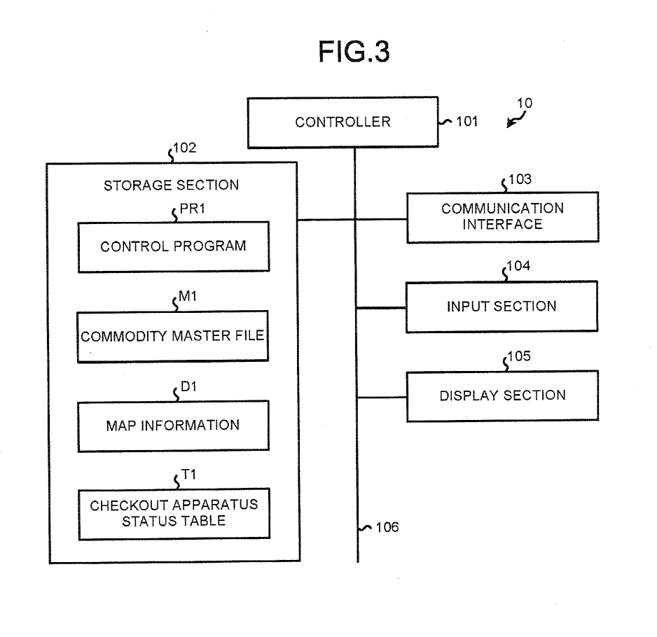

First, the hardware arrangement of the server apparatus 10 is described. FIG. 3 is a block diagram illustrating the hardware arrangement of the server apparatus 10. The server apparatus 10 comprises a controller 101, a storage section 102, a communication interface 103, an input section 104, and a display section 105. The controller 101, the storage section 102, the communication interface 103, the input section 104 and the display section 105 are connected with each other via a system bus line 106.

The controller 101 controls the whole operation of the server apparatus 10 to realize various functions of the server apparatus 10. The controller 101 includes a CPU (Central Processing Unit), a ROM (Read Only Memory), and a RAM (Random Access memory). The CPU collectively controls the operation of the server apparatus 10. The ROM is a storage medium that stores various programs and data. The RAM temporarily stores various programs or rewrites various data. Then, the CPU executes a program stored in the ROM or the storage section 102, using the RAM as a working area (work area).

The storage section 102 is a storage device such as an HDD (Hard Disk Drive) or an SSD (Solid State Drive). The storage section 102 stores a control program PR1, a commodity master file M1, a checkout apparatus status table T1 and map information D1.

The control program PR1 is an operating system or a program for exerting the functions of the server apparatus 10. Then, the control program PR1 includes programs for exerting a characteristic function according to the present embodiment.

The commodity master file M1 is a database for storing information of each commodity. The commodity master file M1 stores a commodity code, a commodity name and a price in an associated manner. The commodity code is capable of identifying the commodity. The commodity name is a name of the commodity. The price is a unit price of the commodity.

The map information D1 is image information of a map which shows locations in arrangement of the checkout apparatuses 40 on a sales floor of the store which introduces the POS system 1.

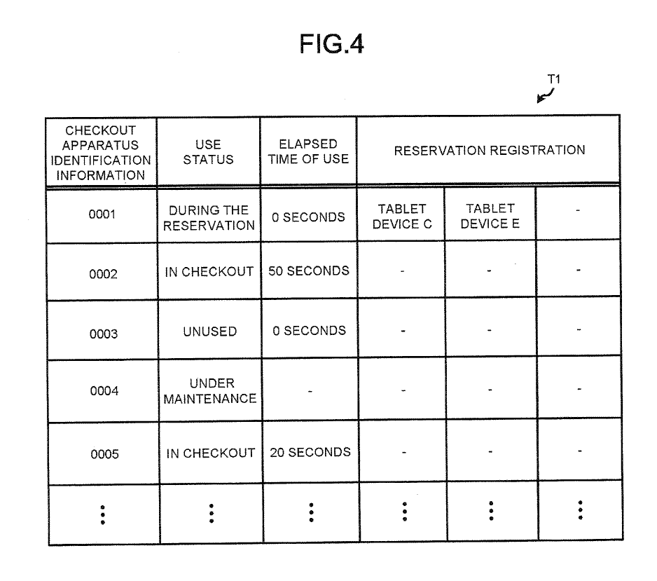

The checkout apparatus status table T1 stores a use status of each checkout apparatus 40 arranged on the sales floor. FIG. 4 is a view illustrating the data structure of the checkout apparatus status table T1. The checkout apparatus status table T1 stores checkout apparatus identification information, the use status, an elapsed time of use and a reservation registration in an associated manner. The checkout apparatus identification information is capable of identifying the checkout apparatus 40. The use status indicates the status of the checkout apparatus 40. In particular, in the use status, the statuses of the checkout apparatus 40 such as “unused state”, “in checkout”, “reserved”, “under maintenance” are set. More particularly, the “unused state” indicates that the checkout apparatus 40 can be immediately used because the checkout apparatus 40 is not being used. The “in checkout” indicates that the checkout apparatus 40 is executing the checkout processing. The “reserved” indicates a state in which there is a tablet device 30 which reserves the use of the checkout apparatus 40 but the checkout processing is not started yet. The “reserved” also indicates a period until a next subscriber starts to use the checkout apparatus 40. The “under maintenance” indicates that the checkout apparatus 40 cannot be used because the maintenance of the checkout apparatus 40 is executed. The “elapsed time of use” indicates an elapsed time from the start of the use of the checkout apparatus 40. The “reservation registration” indicates the tablet device 30 which reserves the checkout apparatus 40.

Return to FIG. 4, the communication interface 103 is an element for connecting with the network N1.

The input section 104 is an input device such as a keyboard, a mouse and the like. The input section 104 receives an operation on the server apparatus 10.

The display section 105 is, for example, a liquid crystal display device (LCD). The display section 105 is not limited to the liquid crystal display device, but may also be an organic EL display device.

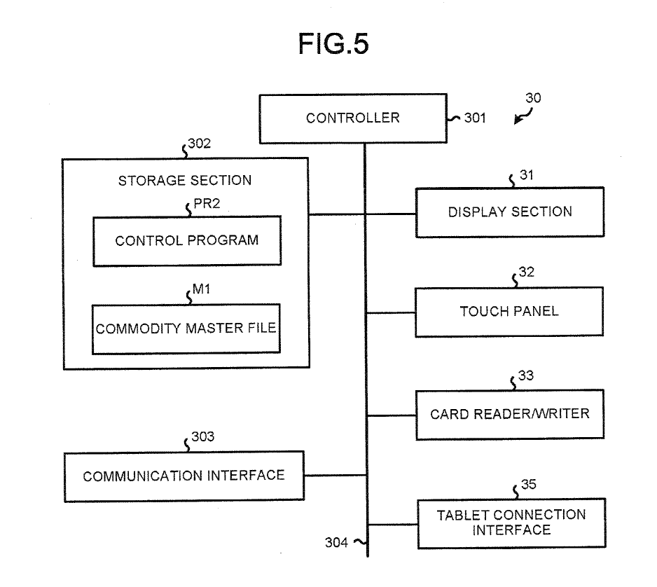

Next, the hardware arrangement of the tablet device 30 is described. FIG. 5 is a block diagram illustrating the hardware arrangement of the tablet device 30. The tablet device 30 comprises a controller 301, a storage section 302, a communication interface 303, a display section 31, a touch panel 32, a card reader/writer 33, and the tablet connection interface 35. The controller 301, the storage section 302, the communication interface 303, the display section 31, the touch panel 32, the card reader/writer 33 and the tablet connection interface 35 are connected with each other via a system bus line 304.

The controller 301 controls the whole operation of the tablet device 30 to realize various functions of the tablet device 30. The controller 301 includes a CPU, a ROM and a RAM. The CPU collectively controls the operation of the tablet device 30. The ROM is a storage medium that stores various programs and data. The RAM temporarily stores various programs or rewrites various data. The CPU executes a program stored in the ROM or the storage section 302, using the RAM as a working area (work area).

The storage section 302 is a storage device such as an HDD or an SSD. The storage section 302 stores a control program PR2 and the commodity master file M1. The control program PR2 is an operating system or a program for exerting the functions of the tablet device 30. Then, the control program PR2 includes programs for exerting a characteristic function according to the present embodiment. The commodity master file M1 is distributed from the server apparatus 10.

The communication interface 303 is an element for connecting with the network N2.

Next, the hardware arrangement of the checkout apparatus 40 is described. FIG. 6 is a block diagram illustrating the hardware arrangement of the checkout apparatus 40. The checkout apparatus 40 comprises a controller 401, a storage section 402, a first communication interface 403, a second communication interface 404, a connection interface 405, the printer 406 and the tablet connection interface 41. The controller 401, the storage section 402, the first communication interface 403, the second communication interface 404, the connection interface 405, the printer 406 and the tablet connection interface 41 are connected with each other via a system bus line 407.

The controller 401 controls the whole operation of the checkout apparatus 40 to realize various functions of the checkout apparatus 40. The controller 401 includes a CPU, a ROM and a RAM. The CPU collectively controls the operation of the checkout apparatus 40. The ROM is a storage medium that stores various programs and data. The RAM temporarily stores various programs or rewrites various data. The CPU executes a program stored in the ROM or the storage section 402, using the RAM as a working area (work area).

The storage section 402 is a storage device such as an HDD or an SSD. The storage section 402 stores a control program PR3. The control program PR3 is an operating system or a program for exerting the functions of the checkout apparatus 40. Then, the control program PR3 includes programs for exerting a characteristic function according to the present embodiment.

The first communication interface 403 is an element for connecting with the network N1. The second communication interface 404 is also an element for connecting with the network N2.

The connection interface 405 is an element for connecting with an external device. The connection interface 405 can be connected with the drawer 50, for example. Alternatively, the connection interface 405 may be connected with an automatic change dispensing machine for automatically dispensing change. Alternatively, the connection interface 405 may be connected with a handy scanner for reading a commodity code.

The printer 406 prints a receipt and a journal.

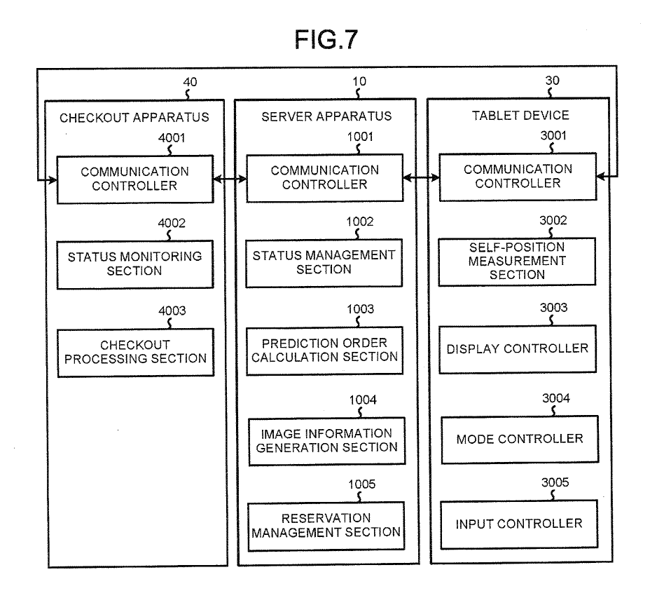

Next, the characteristic function of each apparatus of the POS system 1 is described. FIG. 7 is a block diagram illustrating the functional components of each apparatus of the POS system 1.

First, the functional components of the checkout apparatus 40 are described. The CPU of the controller 401 copies or decompresses the control program PR3 in the storage section 402 on the RAM and operates according to the control program PR3 to generate each functional section shown in FIG. 7 on the RAM. In particular, the controller 401 includes, as functional sections, a communication controller 4001, a status monitoring section 4002 and a checkout processing section 4003.

The communication controller 4001 controls the first communication interface 403 and the second communication interface 404 to communicate with the server apparatus 10 and the tablet device 30.

The status monitoring section 4002 monitors the use status of the checkout apparatus 40. More particularly, the status monitoring section 4002 generates use status information indicating the use status of the checkout apparatus 40 each time a predetermined period elapses. The use status information includes the checkout apparatus identification information, the use status, the elapsed time the checkout apparatus 40 is used. The checkout apparatus identification information is capable of identifying the checkout apparatus 40. The use status indicates the status of the checkout apparatus 40 such as “reserved”, “in checkout”, “unused state”, “under maintenance”. The elapsed time of use indicates elapsed time from the start of the use of the checkout apparatus 40. The communication control section 4001 transmits the use status information generated by the status monitoring section 4002 to the server apparatus 10.

The checkout processing section 4003 uses the checkout information relating to the checkout received from the tablet device 30 to execute the checkout processing. The checkout processing refers to, for example, a processing of controlling the opening of the drawer 50 in a case in which there is change due to cash payment for a total amount in the sales registration of the tablet device 30. Alternatively, the checkout processing refers to a processing of enabling the printer 406 to print a receipt.

Next, the functional components of the server apparatus 10 are described. The CPU of the controller 101 copies or decompresses the control program PR1 in the storage section 102 on the RAM and operates according to the control program PR1 to generate each functional section shown in FIG. 7 on the RAM. In particular, the controller 101 includes, as functional sections, a communication controller 1001, a status management section 1002, a prediction ranking calculation section 1003, an image information generation section 1004 and a reservation management section 1005.

The communication controller 1001 controls the communication interface 103 to communicate with the tablet device 30 and the checkout apparatus 40.

The status management section 1002 manages the use status of the checkout apparatus 40 of the POS system 1. More particularly, the communication controller 1001 acting as a first reception module receives the use status information indicating the use status of each checkout apparatus 40. The status management section 1002 stores information contained in the use status information in the checkout apparatus status table T1 after the communication controller 1001 receives the use status information. In other words, the status management section 1002 updates the use status and the elapsed time of use associated with the checkout apparatus identification information the same as that in the use status information to the use status and the elapsed time of use in the received use status information in the checkout apparatus status table T1.

The prediction ranking calculation section 1003 calculates a prediction ranking of the checkout apparatus 40 which is enabled to be used earlier in order in the checkout apparatuses. In other words, the prediction ranking calculation section 1003 calculates the prediction ranking of the checkout apparatus 40 which can early start the checkout processing based on the checkout apparatus status table T1. The prediction ranking calculation section 1003 sets the prediction ranking of the checkout apparatus 40 which is enabled to be used immediately, for example, a checkout apparatus 40 of which the use status is the unused state, to the first place. The prediction ranking calculation section 1003 sets the prediction ranking based on the prediction time until the checkout apparatus 40 which is unable to be used immediately becomes enabled to be used. The prediction ranking calculation section 1003 calculates the prediction time until the checkout apparatus 40 which is unable to be used immediately becomes enabled to be used based on a use time per one use, the elapsed time of use in the checkout apparatus status table T1 and the number of reservations of the reservation registration. For example, the prediction ranking calculation section 1003 calculates the prediction time to be 240 seconds in a case in which the use time per one use is 100 seconds, the elapsed time of use is 60 seconds, and the number of reservations of the reservation registration is 2. The prediction ranking calculation section 1003 sets the prediction ranking of the checkout apparatus 40 of which the prediction time is short to be high.

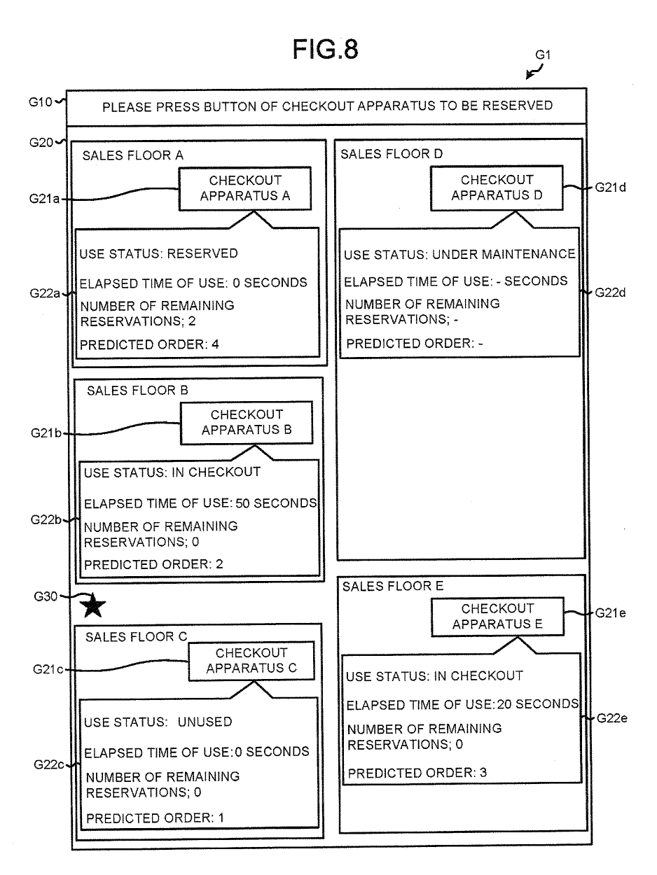

The image information generation section 1004 generates various image information displayed on the display section 31 of the tablet device 30. The image information generation section 1004 enables the communication controller 1001 to transmit the image information to the tablet device 30. The image information refers to information of an image including the use status of each checkout apparatus 40 and an arrangement location of each checkout apparatus 40. In particular, the image information generation section 1004 acting as a generation module generates a message image and a sales floor map image in a reservation input image as the image information. FIG. 8 is a view illustrating a reservation input image G1. The reservation input image G1 is used to reserve the checkout apparatus 40 used in the checkout processing. The reservation input image G1 contains a message image G10, a sales floor map image G20, and a self-position image G30. The self-position image G30 is generated by a display controller 3003 described later.

The message image G10 is an image for displaying a message for urging the input of the reservation. The message image G10 shown in FIG. 8 displays a message “please press button of checkout apparatus to be reserved”.

The sales floor map image G20 is image information containing the use status of each checkout apparatus 40 arranged at the sales floor and a map showing the arrangement location of each checkout apparatus 40. The image information generation section 1004 generates the sales floor map image G20, using the use status of each checkout apparatus 40 stored in the checkout apparatus status table T1 and the map information D1. The sales floor map image G20 includes checkout apparatus buttons G21a, G21b, G21c, G21d and G21e and use status images G22a, G22b, G22c, G22d and G22e. The checkout apparatus buttons G21a, G21b, G21c, G21d and G21e are button images (soft key) for inputting the reservation of the use of the checkout apparatus 40 arranged at the sales floor of the store displayed on the sales floor map image G20. The use status images G22a, G22b, G22c, G22d and G22e displays the use status of each checkout apparatus 40 arranged at the sales floor of the store displayed on the sales floor map image G20. More particularly, the image information generation section 1004 includes the use status, the elapsed time of use, remaining reservation, and the predicted ranking for each of the use status images G22a, G22b, G22c, G22d and G22e. The use status indicates the use status in the checkout apparatus status table T1. The elapsed time of use indicates the elapsed time of use in the checkout apparatus status table T1. The remaining reservation indicates the number of remaining reservations of the checkout apparatuses 40 in the reservation registration of the checkout apparatus status table T1. The predicted ranking is calculated by the prediction ranking calculation section 1003. The communication controller 1001 acting as the transmission module transmits the image information generated by the image information generation section 1004 to the tablet device 30 displaying the reservation input image G1. The image information generation section 1004 overlays the use status images G22a, G22b, G22c, G22d and G22e on the map showing the arrangement location of each checkout apparatus 40, and in this way, an operator can intuitively grasp the use status.

The reservation management section 1005 manages the reservation of the checkout apparatus 40 to be used. In particular, the communication controller 1001 acting as a second reception module receives reservation information relating to the reservation of the checkout apparatus 40 to be used by the tablet device 30 for the checkout processing. The reservation information refers to information of reserving the checkout apparatus 40. The reservation information includes the checkout apparatus identification information of the checkout apparatus 40, i.e., a reservation object, and identification information capable of identifying the tablet device 30 which executes the reservation. The reservation management section 1005 registers the tablet device 30 which executes the reservation in the reservation registration of the checkout apparatus status table T1 after the communication controller 1001 receives the reservation information.

The reservation management section 1005 enables the communication controller 1001 to transmit a use enabled notification to the tablet device 30 on condition that the order of use of the checkout apparatus 40 by the tablet device 30 which executes the reservation thereto comes. The use enabled notification refers to information for notifying the tablet device 30 that the reserved checkout apparatus 40 can be used.

The reservation management section 1005 deletes the reservation by the tablet device 30 from the reservation registration of the checkout apparatus status table T1 on condition that the communication controller 1001 receives a use completion notification. The use completion notification indicates that the use of the checkout apparatus 40 is finished. The use completion notification includes the checkout apparatus identification information of the checkout apparatus 40 and the identification information capable of identifying the tablet device 30 which uses the checkout apparatus 40.

The functional components of the tablet device 30 are described. The CPU of the controller 301 copies or decompresses the control program PR2 in the storage section 302 on the RAM and operates according to the control program PR2 to generate each functional section shown in FIG. 7 on the RAM. In particular, the controller 301 includes, as functional sections, a communication controller 3001, a self-position measurement section 3002, a display controller 3003, a mode controller 3004, and an input controller 3005.

The communication controller 3001 controls the communication interface 303 to communicate with the server apparatus 10 and the checkout apparatus 40.

The self-position measurement section 3002 measures the position of the tablet device 30. The self-position measurement section 3002 presumes the distance between the tablet device 30 and the access point 20 to measure the position of the tablet device 30 based on radio wave strength of a beacon signal to be used in the network detection of the Wi-Fi transmitted from the access point 20. Alternatively, the self-position measurement section 3002 may measure the position of the tablet device 30, using the GPS (Global Positioning System). A method of measuring the position of the tablet device 30 by the self-position measurement section 3002 is an example, and the position of the tablet device 30 may be measured with other known methods.

The display controller 3003 controls the display section 31 to display various screens. For example, the display controller 3003 controls the display section 31 to display the reservation input image G1. The display controller 3003 displays the message image G10, the sales floor map image G20 and the self-position image G30 contained in the image information transmitted from the server apparatus 10 in an overlapped manner as the reservation input image G1. The self-position image G30 is a mark indicating the position of the tablet device 30 measured by the self-position measurement section 3002. The display controller 3003 displays the self-position image G30 on the sales floor map image G20 in an overlaid manner.

The mode controller 3004 controls the mode of the tablet device 30. It is necessary to prevent a collision that a plurality of the tablet devices 30 uses one checkout apparatus 40 at the same timing in the POS system 1. Thus, the mode controller 3004 switches the mode to prevent the occurrence of the collision. In particular, the mode controller 3004 controls switching between a checkout mode and a customer service mode of the tablet device 30. The checkout mode is capable of sending the checkout information for executing the checkout processing to the checkout apparatus 40. The checkout information includes a signal for requesting the checkout apparatus 40 to open the drawer 50, and a printing content of the receipt printed by the printer 406. The customer service mode displays the commodity master file M1 to wait on a customer. In the customer service mode, the checkout information cannot be transmitted to the checkout apparatus 40. The mode controller 3004 sets the mode to the checkout mode on condition that the communication controller 3001 receives the use enabled notification from the server apparatus 10. The mode controller 3004 sets the mode to the customer service mode on condition that the communication controller 3001 receives checkout completion notification from the tablet device 30.

The input controller 3005 controls the touch panel 32 to receive various operations. For example, the input controller 3005 receives an operation for displaying the reservation input image G1 Alternatively, the input controller 3005 receives an operation for transmitting the checkout information to the checkout apparatus 40. Furthermore, the input controller 3005 receives an operation for transmitting the checkout information to the checkout apparatus 40 on condition that the checkout mode is set. In other words, the input controller 3005 does not receive the operation for transmitting the checkout information to the checkout apparatus 40 on condition that the customer service mode is set.

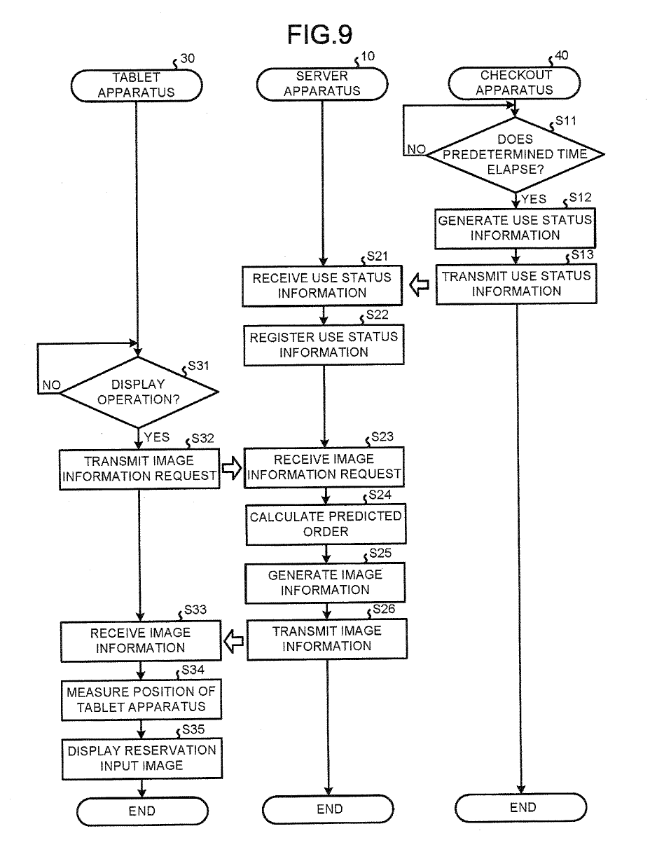

A display processing executed by each apparatus of the POS system 1 is described. FIG. 9 is a flowchart illustrating the display processing executed by each apparatus of the POS system 1 according to the embodiment.

First, the status monitoring section 4002 of the checkout apparatus 40 determines whether or not a predetermined time elapses (Act S11). If the predetermined time does not elapse (No in Act S11), the status monitoring section 4002 of the checkout apparatus 40 stands by until the predetermined time elapses.

On the other hand, if the predetermined time elapses (Yes in Act S11), the status monitoring section 4002 of the checkout apparatus 40 generates the use status information (Act S12). The communication controller 4001 of the checkout apparatus 40 transmits the generated use status information (Act S13).

The communication controller 1001 of the server apparatus 10 receives the use status information (Act S21). The status management section 1002 of the server apparatus 10 registers the received use status information in the checkout apparatus status table T1 (Act S22).

The input controller 3005 of the tablet device 30 determines whether or not an operation for displaying the reservation input image G1 is received (Act S31). If the operation is not received (No in Act S31), the input controller 3005 of the tablet device 30 stands by until the operation is received. On the other hand, if the operation is received (Yes in Act S31), the communication controller 3001 of the tablet device 30 transmits a transmission request of the image information to the server apparatus 10 (Act S32).

The communication controller 1001 of the server apparatus 10 receives the transmission request of the image information (Act S23). The prediction ranking calculation section 1003 of the server apparatus 10 calculates the predicted ranking for guiding the customer to each checkout apparatus 40 based on the checkout apparatus status table T1 (Act S24). The image information generation section 1004 of the server apparatus 10 generates the image information (Act. S25). The communication controller 1001 of the server apparatus 10 transmits the generated image information (Act S26).

The communication controller 3001 of the tablet device 30 receives the image information (Act S33). The self-position measurement section 3002 of the tablet device 30 measures the position of the tablet device 30 (Act S34). The display controller 3003 of the tablet device 30 displays the reservation input image G1 (Act S35).

With the above, each apparatus of the POS system 1 terminates the display processing.

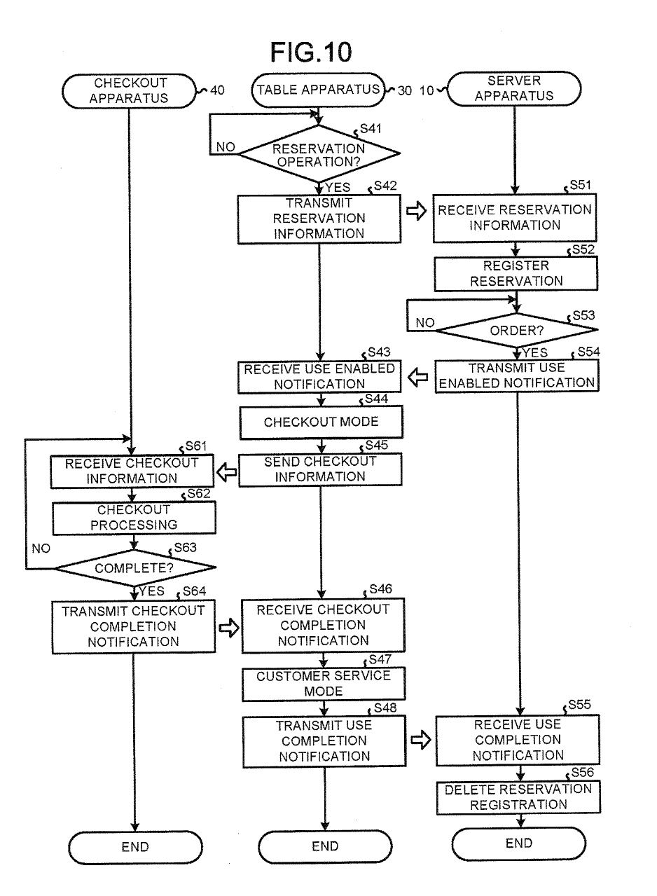

Next, a reservation processing executed by each apparatus of the POS system 1 is described. FIG. 10 is a flowchart illustrating the reservation processing executed by each apparatus of the POS system 1 according to the embodiment.

The input controller 3005 of the tablet device 30 determines whether or not an operation for reserving the checkout apparatus 40 is received (Act S41). If the operation is not received (No in Act S41), the input controller 3005 of the tablet device 30 stands by until the operation is received. On the other hand, if the operation is received (Yes in Act S41), the communication controller 3001 of the tablet device 30 transmits the reservation information (Act S42).

The communication controller 1001 of the server apparatus receives the reservation information (Act S51). The reservation management section 1005 of the server apparatus 10 registers the reservation in the reservation registration of the checkout apparatus status table T1 (Act S52).

The reservation management section 1005 of the server apparatus 10 determines whether or not the order of the tablet device 30 which executes the reservation comes (Act S53). If the order of the tablet device 30 which executes the reservation does not come (No in Act S53), the communication controller 1001 of the server apparatus 10 waits for sending the use enabled notification. On the other hand, if the order of the tablet device 30 which executes the reservation comes (Yes in Act S53), the communication controller 1001 of the server apparatus 10 transmits the use enabled notification (Act S54).

The communication controller 3001 of the tablet device 30 receives the use enabled notification (Act S43). The mode controller 3004 of the tablet device 30 sets the mode to the checkout mode (Act S44). The communication controller 3001 of the tablet device 30 transmits the checkout information to the checkout apparatus 40 according to the operation for transmitting the checkout information (Act S45).

The cause of the transmission of the checkout information is not limited to the detection of the operation. For example, the tablet device 30 may transmit the checkout information if the connection between the tablet connection interface 35 of the tablet device 30 and the tablet connection interface 41 of the checkout apparatus 40 is made, as a cause of action. In this case, the tablet device 30 may transmit the checkout information via the communication interface 303 or the tablet connection interface 35. Alternatively, the tablet device 30 may transmit the checkout information if the distance between the tablet device 30 and the checkout apparatus 40 is equal to or smaller than a predetermined distance, as a cause of action, on condition that the use enabled notification is received.

The communication controller 4001 of the checkout apparatus 40 receives the checkout information (Act S61). The checkout processing section 4003 of the checkout apparatus 40 executes the checkout processing relating to the checkout information (Act S62). The checkout processing section 4003 of the checkout apparatus 40 determines whether or not the checkout processing is completed (Act S63). If the checkout processing is not completed (No in Act S63), the checkout processing section 4003 of the checkout apparatus 40 executes the processing in Act S61. On the other hand, if the checkout processing is completed (Yes in Act S63), the communication controller 4001 of the checkout apparatus 40 transmits the checkout completion notification (Act S64).

The communication controller 3001 of the tablet device 30 receives the checkout completion notification (Act S46). The mode controller 3004 of the tablet device 30 sets the mode to the customer service mode (Act S47). The communication controller 3001 of the tablet device 30 transmits the use completion notification (Act S48).

The communication controller 1001 of the server apparatus 10 receives the use completion notification (Act S55). The reservation management section 1005 of the server apparatus 10 deletes the reservation corresponding to the use completion notification from the reservation registration of the checkout apparatus status table T1 (Act S56).

With the above, each apparatus of the POS system 1 terminates the reservation processing.

As stated above, in the server apparatus 10 of the POS system 1 according to the embodiment, the communication controller 1001 receives the use status information from each checkout apparatus 40 which uses the checkout information relating to the checkout received from the tablet device 30 to execute the checkout processing. The status management section 1002 stores the information contained in the use status information in the checkout apparatus status table T1. The image information generation section 1004 generates the image information in a case in which the transmission request of the message image G10 and the sales floor map image G20 contained in the reservation input image G1 from the tablet device 30. The communication controller 1001 transmits the image information generated by the image information generation section 1004 to the tablet device 30. Thus, the server apparatus 10 according to the embodiment can notify the checkout apparatus 40 that is enabled to be used earlier. The tablet device 30 displays the image of the map showing the arrangement location of each checkout apparatus 40 at the sales floor and the reservation input image G1 indicating the use status of the checkout apparatus 40. Thus, the store clerk can guide the customer to the checkout apparatus 40 which can start the checkout processing early.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

In the foregoing embodiment, it is described that the image information generation section 1004 displays the map of the sales floor at which the checkout apparatuses 40 are arranged as the reservation input image G1. However, the image information generation section 1004 is not limited to display the map of the sales floor at which the checkout apparatuses 40 are arranged, but may also display a list of locations where the checkout apparatuses 40 are arranged.

The programs executed by each apparatus of the foregoing embodiment and the modification may be incorporated into a storage medium (ROM or storage section) of each apparatus to be provided; however, the present invention is not limited to this. The programs may be recorded in a computer-readable storage medium such as a CD-ROM, a FD (Flexible Disk), a CD-R, a DVD (Digital Versatile Disk) and the like in the form of installable or executable file to be provided. Further, the storage medium is not limited to a medium independent from a computer or an embedded system but also contains a storage medium that stores or temporarily stores the programs by downloading the programs transmitted through a LAN or an Internet.

Further, the programs executed by each device of the foregoing embodiment and the modification is stored in a computer connected with a network and downloaded via the network to be supplied or may be supplied or distributed via the network such as the Internet.

What is claimed is:

1. A server apparatus which communicates with a portable terminal, comprising:
a first reception module configured to receive a use status of each checkout apparatus which executes a checkout processing using checkout information relating to checkout received from the portable terminal;
a generation module configured to generate image information including the use status of each checkout apparatus received by the first reception module and an arrangement location of each checkout apparatus; and
a transmission module configured to transmit the image information generated by the generation module to the portable terminal which displays the image information.

2. The server apparatus according to claim 1, further comprising:
a second reception module configured to receive reservation of the checkout apparatus used in the checkout processing by the portable terminal.

3. The server apparatus according to claim 1, wherein
the generation module generates the image information including the use status indicating a ranking of the checkout apparatus in a descending order in which the checkout apparatus is enabled to be used early and an arrangement location of each checkout apparatus, and
the transmission module transmits the image information generated by the generation module to the portable terminal which displays the image information.

4. The server apparatus according to claim 2, wherein
the generation module generates the image information including the use status indicating a ranking of the checkout apparatus in a descending order in which the checkout apparatus is enabled to be used early and an arrangement location of each checkout apparatus, and
the transmission module transmits the image information generated by the generation module to the portable terminal which displays the image information.

5. The server apparatus according to claim 2, wherein
the generation module generates the image information including the use status indicating the number of remaining reservations of the checkout apparatus and the arrangement location of each checkout apparatus, and
the transmission module transmits the image information generated by the generation module to the portable terminal which displays the image information.

6. The server apparatus according to claim 3, wherein
the generation module generates the image information including the use status indicating the number of remaining reservations of the checkout apparatus and the arrangement location of each checkout apparatus, and
the transmission module transmits the image information generated by the generation module to the portable terminal which displays the image information.

7. The server apparatus according to claim 1, wherein
the generation module generates the image information including the use status indicating an elapsed time from start of the use of the checkout apparatus and the arrangement location of each checkout apparatus, and
the transmission module transmits the image information generated by the generation module to the portable terminal which displays the image information.
